(19) United States
(12) Patent Application Publication
(10) Pub. No.: US 2019/0073969 A1
(43) Pub. Date: Mar. 7, 2019

(54) DRIVING METHOD OF DISPLAY PANEL, DRIVING DEVICE AND DISPLAY DEVICE

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Jianjun LI, Beijing (CN); Jun NIE, Beijing (CN)

(21) Appl. No.: 15/762,288

(22) PCT Filed: Jul. 25, 2017
(86) PCT No.: PCT/CN2017/094290

§ 371 Date: Mar. 22, 2018

(30) Foreign Application Priority Data
Oct. 28, 2016 (CN) 201610965795.9

(51) Int. Cl. G09G 3/36

(52) U.S. Cl. CPC G09G 3/3614; G02F 2001/134345; G09G 3/3677

(57) ABSTRACT

A driving method of a display panel includes: in display time of an (a)th frame, applying a pixel voltage signal to each of the sub-pixels of the display panel, so that every 2ⁿ⁺¹ consecutive pixel rows form one pixel polarity repeat group, wherein polarities of pixel voltage signal of any two adjacent sub-pixels in same one pixel row in each of the pixel polarity repeat groups are in inverse; in display time of an (a+1)th frame, applying a pixel voltage signal to each of the sub-pixels, so that first 2ⁿ pixel rows and last 2ⁿ pixel rows of each of the pixel polarity repeat groups each meet a preset polarity condition. A driving device for a display panel and a display device are disclosed as well.

### TECHNICAL FIELD

Embodiments of the present disclosure relate to a driving method of a display panel, a driving device and a display device.

### BACKGROUND

Liquid crystal display panels are display panels that are widely applied, and in the display process of a liquid crystal display panel, it is necessary that liquid crystal molecules be driven to flip over at a certain frequency, so as to guarantee activity of liquid crystal molecules. At present, a liquid crystal display panel supports a various kinds of reverse modes, such as a frame reverse mode, a row reverse mode, a column reverse mode and a dot reverse mode, and the dot reverse mode generally includes a single-dot reverse mode and a 2ⁿ-dot reverse mode, n is an integer greater than or equal to 1, and the 2ⁿ-dot reverse mode is such as two-dot reverse mode, four-dot reverse mode, eight-dot reverse mode, or the like.

A liquid crystal display panel includes sub-pixels arranged in a matrix, which includes pixel rows and pixel columns, and a plurality of sub-pixels are included in each of the pixel rows and each of the pixel columns, respectively. Each of the sub-pixels includes a thin film transistor (TFT) and liquid crystal molecules. Gate electrodes of TFTs of a plurality of sub-pixels in each of the pixel rows are connected to the same gate line of the liquid crystal display panel, and source electrodes of TFTs of a plurality of sub-pixels in each of the pixel columns are connected to the same data line of the liquid crystal display panel. Turning-on and turning-off of a TFT can be controlled by the voltage signal applied over the gate line, and when the TFT is turned on, the voltage signal over the data line can be written into a sub-pixel to charge the sub-pixel. Polarity of the source voltage signal applied to the TFT can be changed by periodically changing polarity of the voltage signal applied to the data line, and then, liquid crystal molecules are driven to flip over. The source voltage signal of the TFT of each sub-pixel may be referred to as a pixel voltage signal of the sub-pixel, and polarity of a voltage signal includes a positive polarity and a negative polarity. In a related technology, when a 2ⁿ-dot reverse mode is employed to drive liquid crystal molecules to flip over, at the time when an (a)-th frame is displayed, a pixel voltage signal whose amplitude is equal to a preset amplitude may be applied to each of sub-pixels of the display panel, so that every 2ⁿ pixel rows of the display panel form one pixel group and then a plurality of pixel groups are obtained. In each of the pixel groups, polarities of pixel voltage signal of any two adjacent sub-pixels in the same pixel row are in inverse, and polarities of pixel voltage signal of all sub-pixels in the same pixel column are the same. Moreover, polarities of pixel voltage signal of sub-pixels in the same pixel column in any two adjacent two pixel groups are in inverse. At the time when an (a+1)th frame is displayed, a pixel voltage signal whose amplitude is equal to a preset amplitude is applied to each of sub-pixels of the display panel, and this causes polarities of pixel voltage signal of all sub-pixels to change with respect to the polarities thereof at the time when an (a)th frame is displayed, so as to drive liquid crystal molecules to flip over, where “a” is an integer greater than or equal to 1.

During implementation of the above disclosure, the inventors have noted that the related technology has at least the following problems:

During the course of driving liquid crystal molecules to flip over in the related technology, the polarities of pixel voltage signal of all sub-pixels of the display panel have been changed. Hence, pixel voltage signals of sub-pixels in the first pixel row in each of pixel groups need to undergo a rising or falling edge, and only after this operation can their amplitudes reach preset amplitudes. This will lead to the fact that the actual charging durations of sub-pixels in the first pixel row in each of the pixel groups are less than the charging durations of other sub-pixels in the pixel group. Consequently, luminance of sub-pixels in the first pixel row is smaller than luminance of other sub-pixels in the pixel group, and the position of the pixel row with smaller luminance in different frames is the same. This easily causes such a defect as bright and dark stripes that are visible to human eyes to appear on the display panel.

### SUMMARY

According to at least one embodiment of the present disclosure, a driving method of a display panel is provided, the display panel comprising a plurality of sub-pixels arranged in a form of a matrix, which include a plurality of pixel rows and a plurality of pixel columns, and each of pixel rows and each of pixel columns comprising sub-pixels respectively, the method comprising:

in a 2ⁿ-dot reverse mode, with display duration of 2ⁿ⁺¹ frames as a scan cycle, performing a scan action repetitively, the scan action including:

in display time of an (a)th frame, applying a pixel voltage signal to each of the sub-pixels of the display panel, so that every 2ⁿ⁺¹ consecutive pixel rows of the display panel form one pixel polarity repeat group and a plurality of pixel polarity repeat groups are obtained, wherein polarities of pixel voltage signal of any two adjacent sub-pixels in same one pixel row in each of the pixel polarity repeat groups are in inverse, and for same one pixel column in each of the pixel polarity repeat groups, a polarity of pixel voltage signal of sub-pixel in an (i)th pixel row and a polarity of pixel voltage signal of sub-pixel in a (2+i)th pixel row are in inverse, and a, n and i are all integers greater than or equal to 1, and a<2ⁿ⁻¹, i≤2ⁿ;

in display time of an (a+1)th frame, applying a pixel voltage signal to each of the sub-pixels of the display panel, so that first 2ⁿ pixel rows of each of the pixel polarity repeat groups and last 2ⁿ pixel rows of each of the pixel polarity repeat groups each meet a preset polarity condition, wherein the preset polarity condition is that, polarities of pixel voltage signal of sub-pixels of b pixel rows remain unchanged, and polarities of pixel voltage signal of sub-pixels of rest pixel rows are changed, the b pixel rows in the first 2ⁿ pixel rows are not adjacent to the b pixel rows in the last 2ⁿ pixel rows, b is an integer greater than or equal to 1, and b<2ⁿ, and moreover, in case that bis larger than 1, the b pixel rows are consecutive.

In an embodiment, applying a pixel voltage signal to each of the sub-pixels of the display panel, so that the first 2ⁿ pixel rows of each of the pixel polarity repeat groups and the last 2ⁿ pixel rows of each of the pixel polarity repeat groups each meet the preset polarity condition in the display time of an (a+1)th frame includes: in the display time of the (a+1)th frame, applying a pixel voltage signal to each of sub-pixels of the display panel, so that polarities of pixel voltage signal of sub-pixels in an (m×2ⁿ−(a−1))th pixel row in each of pixel polarity repeat groups maintain unchanged with respect to the polarities in the display time of the (a)th frame, and polarities of pixel voltage signal of sub-pixels in the rest pixel rows are changed with respect to the polarities in the display time of the (a)th frame, wherein m is an integer greater than or equal to 1.

In an embodiment, display time of all of the 2ⁿ⁺¹ frames is equal.

In an embodiment, applying a pixel voltage signal to each of the sub-pixels of the display panel comprises: applying a pixel voltage signal, an amplitude of which is equal to a preset amplitude, to each of the sub-pixels of the display panel.

In an embodiment, in display time of different frames, amplitudes of pixel voltage signals applied to each of sub-pixels of the display panel are equal.

In an embodiment, the display panel is a liquid crystal display panel.

According to at least one embodiment of the present disclosure, a driving device of a display panel is provided, the display panel comprising a plurality of sub-pixels arranged in a form of a matrix, which include a plurality of pixel rows and a plurality of pixel columns, and each of pixel rows and each of pixel columns comprising sub-pixels respectively, the driving device of the display panel comprising:

a scan module, configured for in a 2ⁿ-dot reverse mode, with display duration of 2ⁿ⁻¹ frames as a scan cycle, performing a scan action repetitively,

the scan module comprising: a first applying sub-module, configured for applying a pixel voltage signal to each of the sub-pixels of the display panel, so that every 2ⁿ⁺¹ consecutive pixel rows of the display panel form one pixel polarity repeat group and a plurality of pixel polarity repeat groups are obtained, wherein polarities of pixel voltage signal of any two adjacent sub-pixels in same one pixel row in each of the pixel polarity repeat groups are in inverse, and for same one pixel column in each of the pixel polarity repeat groups, a polarity of pixel voltage signal of sub-pixel in an (i)th pixel row and a polarity of pixel voltage signal of sub-pixel in a (2+i)th pixel row are in inverse, and a, n and i are all integers greater than or equal to 1, and a<2ⁿ⁺¹, i≤2ⁿ; a second applying sub-module, configured for in display time of an (a+1)th frame, applying a pixel voltage signal to each of the sub-pixels of the display panel, so that first 2ⁿ pixel rows of each of the pixel polarity repeat groups and last 2ⁿ pixel rows of each of the pixel polarity repeat groups each meet a preset polarity condition, wherein the preset polarity condition is that, polarities of pixel voltage signal of sub-pixels of b pixel rows remain unchanged, and polarities of pixel voltage signal of sub-pixels of rest pixel rows are changed, the b pixel rows in the first 2ⁿ pixel rows are not adjacent to the b pixel rows in the last 2ⁿ pixel rows, b is an integer greater than or equal to 1, and b<2ⁿ, and moreover, in case that b is larger than 1, the b pixel rows are consecutive.

In an embodiment, the second applying sub-module further is configured for in the display time of the (a+1)th frame, applying a pixel voltage signal to each of sub-pixels of the display panel, so that polarities of pixel voltage signal of sub-pixels in an (m×2ⁿ−(a−1))th pixel row in each of pixel polarity repeat groups maintain unchanged with respect to the polarities in the display time of the (a)th frame, and polarities of pixel voltage signal of sub-pixels in the rest pixel rows are changed with respect to the polarities in the display time of the (a)th frame, wherein m is an integer greater than or equal to 1.

In an embodiment, display time of all of the 2ⁿ⁺¹ frames is equal.

In an embodiment, each of the first applying sub-module and the second applying sub-module acts to apply a pixel voltage signal, an amplitude of which is equal to a preset amplitude, to each of the sub-pixels of the display panel.

In an embodiment, in display time of different frames, amplitudes of pixel voltage signals applied to each of sub-pixels of the display panel are equal.

In an embodiment, the display panel is a liquid crystal display panel.

According to at least one embodiment of the present disclosure, a display device is provided, the display device comprises a display panel and the driving device of the second aspect.

According to the driving method of a display panel, the driving device, and the display device provided by an embodiment of the present disclosure, within each scan cycle, in the course of driving liquid crystal molecules to flip over, the first 2ⁿ pixel rows of each of the pixel polarity repeat groups and the last 2ⁿ pixel rows of each of the pixel polarity repeat groups each meet a preset polarity condition. The preset polarity condition is that, polarities of pixel voltage signal of sub-pixels of b pixel rows remain unchanged, and polarities of pixel voltage signal of sub-pixels of the rest pixel rows is changed, wherein the b pixel rows in the first 2ⁿ pixel rows are not adjacent to the b pixel rows in the last 2ⁿ pixel rows, and b is an integer greater than or equal to 1. Owing to the fact that polarities of pixel voltage signal of sub-pixels of b pixel rows remain unchanged, and polarities of pixel voltage signal of sub-pixels of the rest pixel rows are changed, such the problem that the defect of bright and dark stripes which are visible to human eyes occurs to the display panel can be solved. Thus, the effect of alleviating occurrence of the defect of bright and dark stripes which are visible to human eyes to the display panel is achieved.

It shall be understood that, the general description hereinbefore and the detailed description in the following text are merely exemplary, and cannot be construed as limitation to the present disclosure.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1-1 is a structurally schematic view showing a display panel related to an embodiment of the present disclosure;

FIG. 1-2 is a diagram showing the driving mechanism of a display panel related to an embodiment of the present disclosure;

FIG. 1-3 is a diagram showing the driving mechanism of another display panel related to an embodiment of the present disclosure;

FIG. 1-4 is a schematic view showing the polarity variance of a pixel voltage signal of each sub-pixel of a display panel in the display time of four consecutive frames provided by a related technology;

FIG. 1-5 is a schematic view showing variances in luminance and polarity of a pixel voltage signal for sub-pixels in pixel column S1 as shown in FIG. 1-4 in the display time of four consecutive frames;

FIG. 1-6 is a schematic view showing luminance of sub-pixels in pixel column S1 shown in FIG. 1-5 in the display time of four consecutive frames;

FIG. 2-1 is a method flowchart showing a driving method of a display panel provided by an embodiment of the present disclosure;

FIG. 2-2 is a flowchart showing a method of applying pixel voltage signals to sub-pixels of a display panel in the display time of two adjacent frames provided by the embodiment shown in FIG. 2-1;

FIG. 2-3 is a schematic view showing the polarity variance of a pixel voltage signal of each sub-pixel of a display panel in the display time of four consecutive frames provided by an embodiment of the present disclosure;

FIG. 2-4 is a schematic view showing variances in luminance and polarity of a pixel voltage signal for sub-pixels in pixel column S1 as shown in FIG. 2-3 in the display time of four consecutive frames;

FIG. 2-5 is a schematic view showing luminance of sub-pixels in pixel column S1 shown in FIG. 2-4 in the display time of four consecutive frames;

FIG. 2-6 is a schematic view showing a repeating unit provided by an embodiment of the present disclosure;

FIG. 2-7 is a schematic view showing the polarity variance of a pixel voltage signal of each sub-pixel of a display panel in the display time of eight consecutive frames provided by an embodiment of the present disclosure;

FIG. 2-8 is a schematic view showing variances in luminance and polarity of a pixel voltage signal for sub-pixels in pixel column S1 as shown in FIG. 2-7 in the display time of eight consecutive frames;

FIG. 2-9 is a schematic view showing luminance of sub-pixels in pixel column S1 shown in FIG. 2-8 in the display time of eight consecutive frames;

FIG. 3-1 is a block diagram showing a driving device of a display panel provided by an embodiment of the present disclosure;

FIG. 3-2 is a block diagram showing a scan module provided by the embodiment shown in FIG. 3-1.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Before a detailed explanation is performed as to technical schemes of embodiments of the present disclosure, first of all, a display panel involved in embodiments of the present disclosure and driving mechanism of the display panel involved in embodiments of the present disclosure will be briefly described.

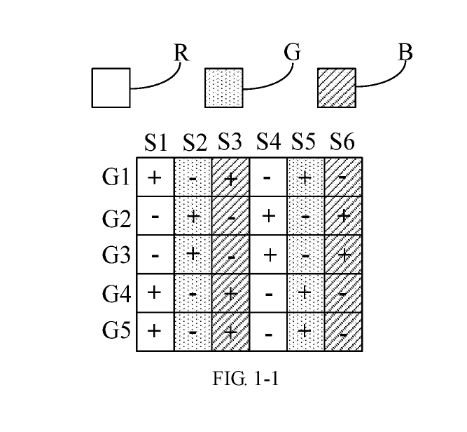

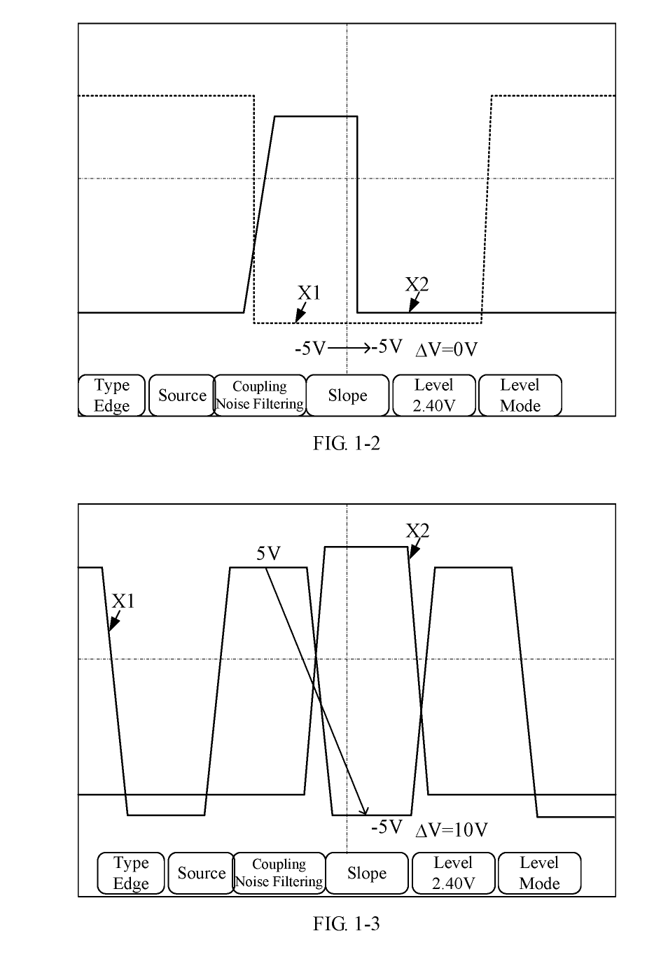

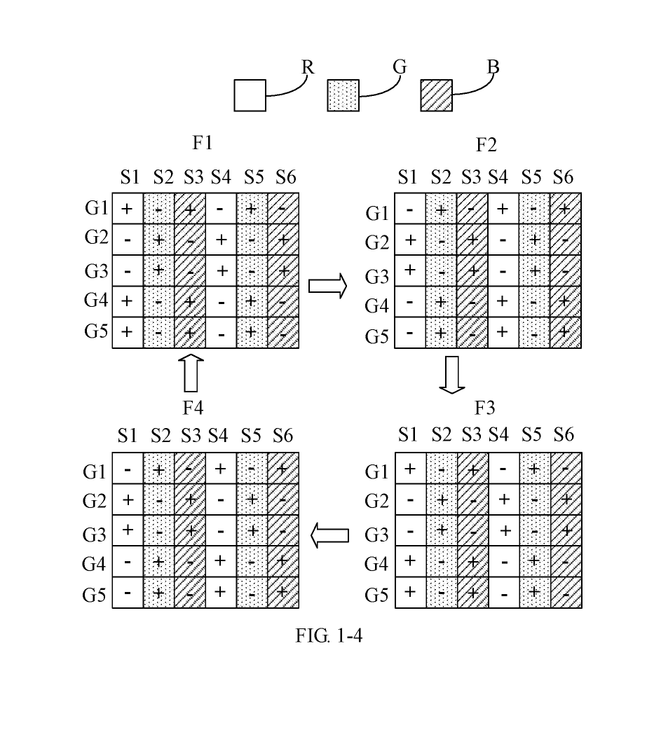

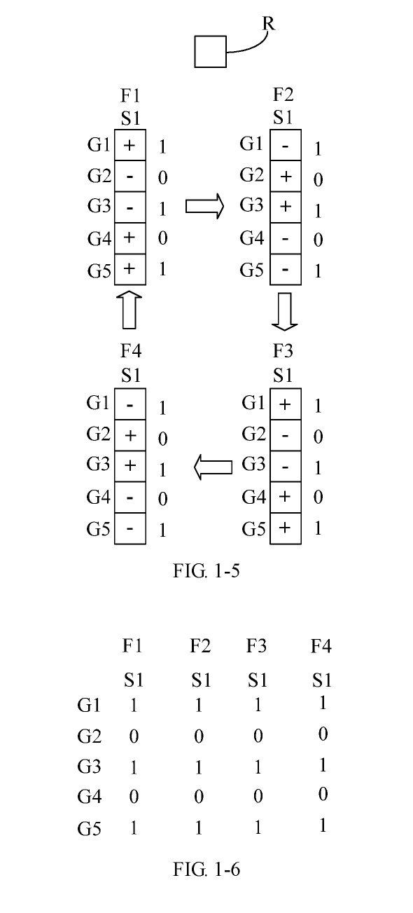

Please refer to FIG. 1-1, which is a structurally schematic view illustrating a display panel (not denoted in FIG. 1-1) involved in embodiments of present disclosure, the display panel includes a plurality of sub-pixels (not denoted in FIG. 1-1) arranged in the form of a matrix, which includes a plurality of pixel rows and a plurality of pixel columns, and a plurality of sub-pixels are included in each of the pixel rows and each of pixel columns, respectively. As shown in FIG. 1-1, the display panel includes such Five pixel rows as pixel rows G1 to G5 and such six pixel columns as pixel columns S1 to S6, six sub-pixels are included in each of the pixel rows, and five sub-pixels are included in each of the pixel columns. In FIG. 1-1, five sub-pixels in the same pixel column have the same color, and for example, Five sub-pixels in pixel column S1 are all red (briefly R) sub-pixels, five sub-pixels in pixel column S2 are all green (briefly G) sub-pixels, and five sub-pixels in pixel column S3 are all blue (briefly B) sub-pixels. It is to be noted that, description is made here with reference to an example in which a display panel includes five pixel rows and six pixel columns, and a plurality of sub-pixels in the same pixel column have the same color, and the display panel includes R sub-pixels, G sub-pixels and B sub-pixels. In actual applications, number of pixel rows and pixel columns of a display panel can be set according to actual requirements. A plurality of sub-pixels in the same pixel column may have different colors, and the display panel may further include sub-pixels in other color, or the display panel only includes sub-pixels in two colors. Embodiments of the present disclosure do not set a limit to this.

In an embodiment of the present disclosure, the display panel further includes a plurality of gate lines (not shown in FIG. 1-1) and a plurality of data lines (not shown in FIG. 1-1), and each of the sub-pixels of the display panel includes a TFT (not shown in FIG. 1-1) and liquid crystal molecules (not shown in FIG. 1-1). Gate electrodes of TFTs of a plurality of sub-pixels in each of the pixel rows are connected to the same gate line of the display panel, and source electrodes of TFTs of a plurality of sub-pixels in each of the pixel columns are connected to the same data line of the display panel. Turning-on and turning-off of a TFT can be controlled by a voltage signal on a gate line, and when the TFT is turned on, a voltage signal on a data line can be written into a sub-pixel to charge the sub-pixel. Polarity of a source voltage signal of the TFT may be changed by periodically changing polarity of the voltage signal applied to the data line, and then, liquid crystal molecules are driven to flip over. Wherein source voltage signal of a TFT of each sub-pixel may be referred to as a pixel voltage signal of the sub-pixel, and polarity of a voltage signal includes a positive polarity and a negative polarity. Exemplarily, as shown in FIG. 1-1, polarity of sub-pixels on the display panel in the display time of a certain frame is illustrated, wherein “+” indicates that polarity of a pixel voltage signal of a sub-pixel is a positive polarity, and “−” indicates that polarity of a pixel voltage signal of a sub-pixel is a negative polarity.

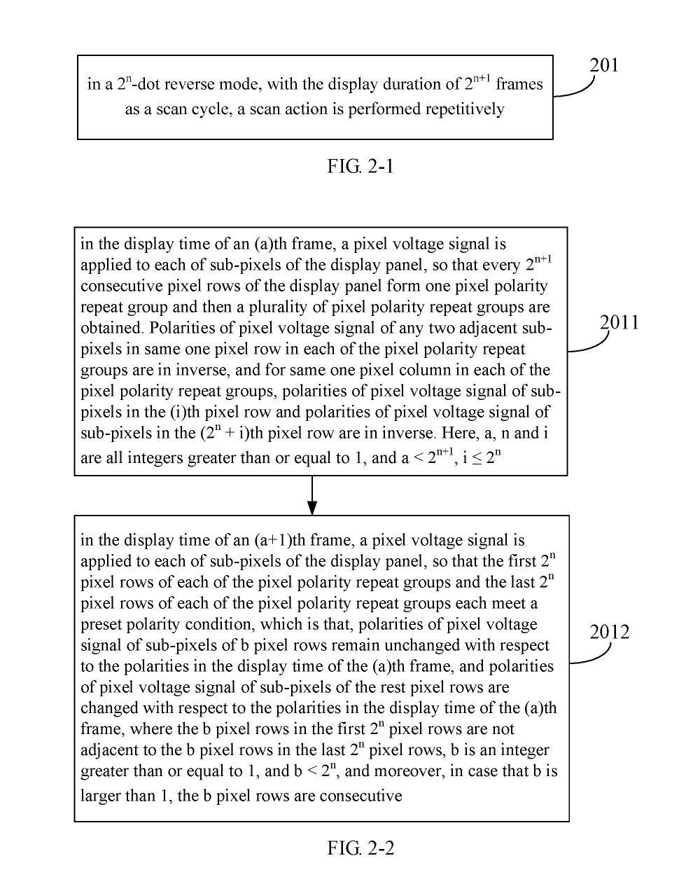

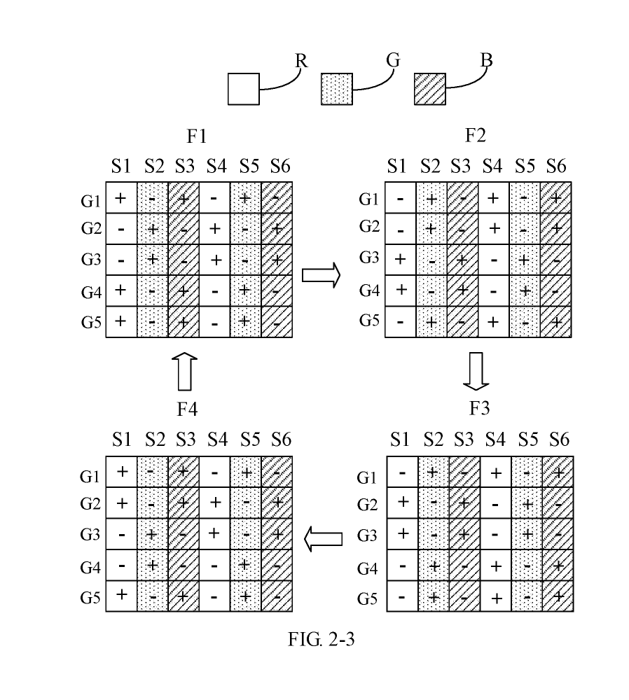

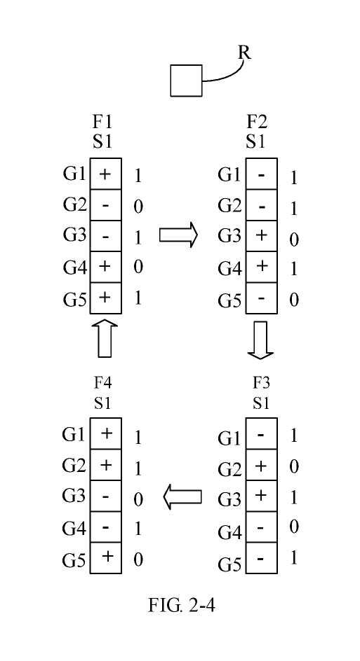

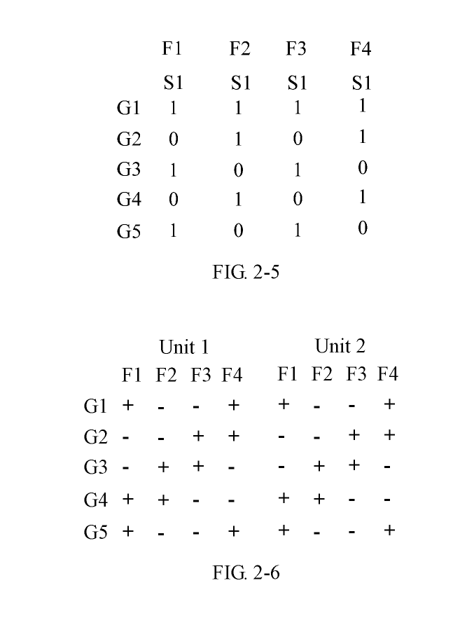

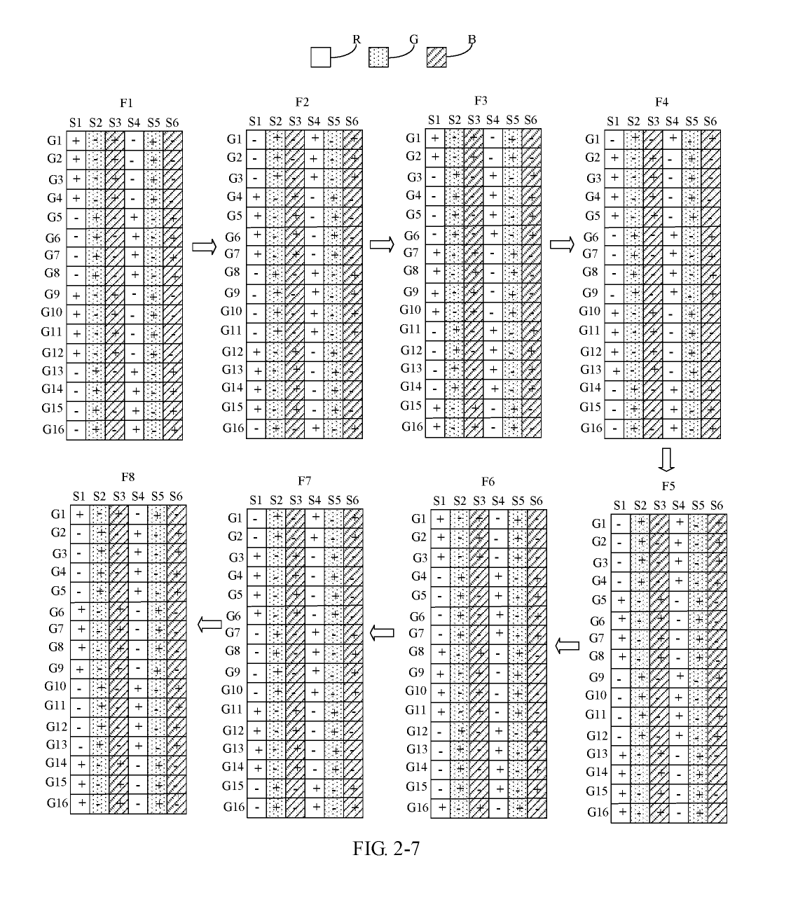

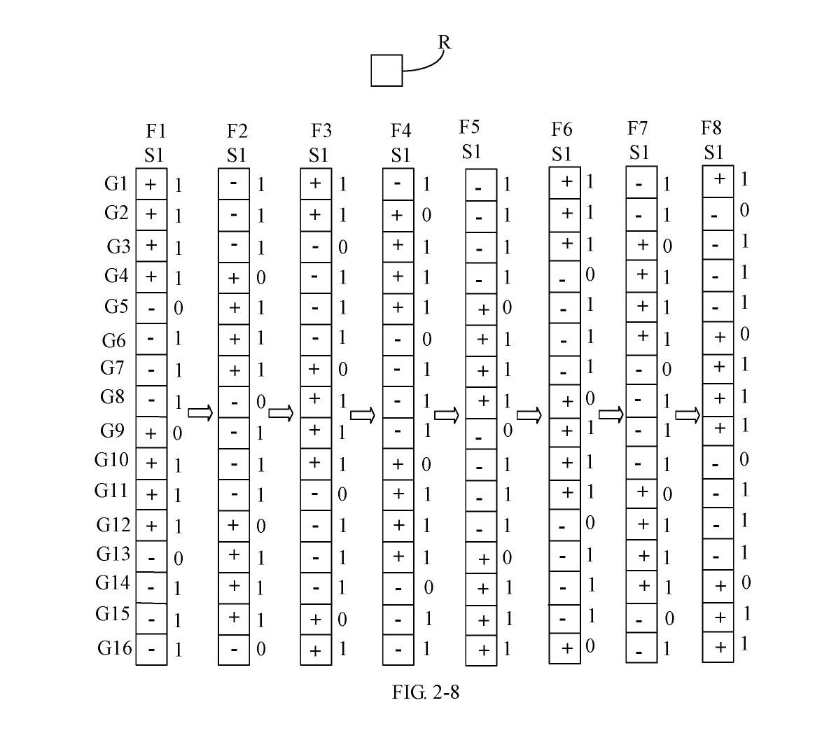

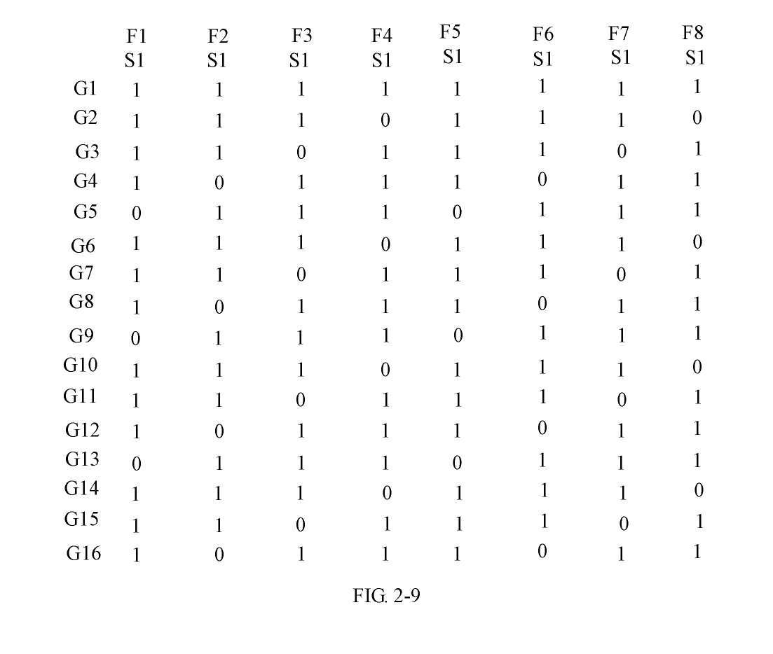

Please refer to FIG. 1-2 and FIG. 1-3, each of which is a diagram showing the driving mechanism of a display panel provided by an embodiment of the present disclosure. Sub-pixel X1 and sub-pixel X2 are two adjacent sub-pixels in the same pixel column, and moreover sub-pixel X1 is situated in a pixel row previous to the row where sub-pixel X2 is situated, and a source electrode of sub-pixel X1 and a source electrode of sub-pixel X2 are connected to the same data line. Exemplarily, sub-pixel X1 and sub-pixel X2 are two adjacent sub-pixels in pixel column S1 as shown in FIG. 1-1, and moreover, sub-pixel X1 is located in pixel row G1, and sub-pixel X2 is located in pixel row G2. Referring to FIG. 1-2, at the same gray-level (i.e., amplitude of pixel voltage signal is equal), polarity of the pixel voltage signal of sub-pixel X1 and polarity of the pixel voltage signal of sub-pixel X2 are the same, and then sub-pixel X1 and sub-pixel X2 can be charged in sequence by a voltage signal (i.e., a source voltage signal) on the data line connected to both sub-pixel X1 and sub-pixel X2 at the same gray-level without the need of changing the voltage signal. In the course of charging sub-pixel X1 and sub-pixel X2, the voltage signal on the data line is kept at −5V (voltage), and variance of the voltage signal on the data line is 0V. Therefore, in the display time period of the same frame, sub-pixel X1 and sub-pixel X2 can reach the same sub-pixel voltage (liquid crystal voltage), and sub-pixel X1 and sub-pixel X2 suffer no such case where luminance is non-uniform in vision. That is, sub-pixel X1 in pixel row G1 and sub-pixel X2 in pixel row G2 suffer no such case where luminance is non-uniform. Likewise, other sub-pixel in pixel row G1 and a sub-pixel in pixel row G2 in the same pixel column as the other sub-pixel in pixel row G1 suffer no such where luminance is non-uniform. Consequently, pixel row G1 and pixel row G2 suffer no such case where luminance is non-uniform. Likewise, pixel row G2 and pixel row G3, pixel row G3 and pixel row G4, and so on have no such case where luminance is non-uniform, and in turn, bright and dark stripes do not appear on the display panel. Referring to F1G. 1-3, at the same gray-level, pixel voltage signal of sub-pixel X1 is 5V, pixel voltage signal of sub-pixel X2 is −5V, and the polarity of pixel voltage signal of sub-pixel X1 and the polarity of pixel voltage signal of sub-pixel X2 differ from each other. Then, at the same gray-level, the voltage signal on the data line connected to sub-pixel X1 and sub-pixel X2 needs to be changed, and by this change sub-pixel X1 and sub-pixel X2 can be charged in sequence, and variance amount of the voltage signal on the data line is 10V, which is equivalent to charge a capacitor by 10V. In this case, due to the fact that the voltage signal on the data line needs to undergo a rising edge or a falling edge and thus sub-pixel X1 and sub-pixel X2 can be charged, the time taken for charging a sub-pixel (a liquid crystal capacitor in the sub-pixel) actually becomes shorter. If load of the display panel is bigger, then RC Delay (resistance-capacitance delay) increases, and time for a rising edge or a falling edge of the voltage signal on the data line becomes further longer. As a result, time taken for charging of the sub-pixel actually becomes further shorter. For example, after sub-pixel X1 is charged by a voltage signal on a data line, it needs to undergo a falling edge, and in this way sub-pixel X2 can be charged. This causes the time taken for charging of sub-pixel X2 becomes shorter. If load of the display panel is bigger, then the time taken for charging of sub-pixel X2 becomes further shorter. As such, sub-pixel X1 is charged completely, and sub-pixel X2 is charged insufficiently. In turn, the luminance of sub-pixel X1 is relatively higher, while the luminance of sub-pixel X2 is relatively lower. That is, sub-pixel X1 in pixel row G1 and sub-pixel X2 in pixel row G2 have a relatively large luminance difference. Likewise, other sub-pixel in pixel row G1 and the sub-pixel in pixel row G2 in the same pixel column as the other sub-pixel in pixel row G1 have a relatively large luminance difference. Consequently, pixel row G1 and pixel row G2 have a relatively large luminance difference. Likewise, pixel row G2 and pixel row G3, pixel row G3 and pixel row G4, and so on have relatively large luminance differences, and this situation exists in each of frames. So, the case of bright and dark stripes that are visible to human eyes happens to the display panel easily.

Please refer to FIG. 1-4, which is a schematic view showing the polarity variance of the pixel voltage signal of each sub-pixel of a display panel in the display time of four consecutive frames in a related technology, and the reverse mode represented by FIG. 1-4 is a (1+2)dot reverse mode. Referring to FIG. 1-4, description will be made by taking pixel column S1 as an example. In the display time of frame F1 (e.g., the first frame), polarity of pixel voltage signal of five R sub-pixels in pixel column S1 is “+−−++” in sequence from pixel row G1 to pixel row G5; in the display time of frame F2 (e.g., the second frame), polarity of pixel voltage signal of five R sub-pixels in pixel column S1 is “−++−−” in sequence from pixel row G1 to pixel row G5; and in the display time of frame F3 (e.g., the third frame), polarity of pixel voltage signal of five R sub-pixels in pixel column S1 is “+−−++” in sequence from pixel row G1 to pixel row G5; and in the display time of frame F4 (e.g., the fourth frame), polarity of pixel voltage signal of five R sub-pixels in pixel column S1 is “−++−−” in sequence from pixel row G1 to pixel row G5.

Please refer to FIG. 1-5, which is a schematic view showing variances in luminance and polarity of a pixel voltage signal for sub-pixels in pixel column S1 as shown in FIG. 1-4 in the display time of four consecutive frames, and in this disclosure, two numbers as 1, 0 are used to denote brightness and darkness of sub-pixels. Provided that the sub-pixel in pixel row G1 as well as in pixel column S1 is sub-pixel X1 (not denoted in FIG. 1-5), the sub-pixel in pixel row G2 as well as in pixel column S1 is sub-pixel X2 (not denoted in FIG. 1-5), the sub-pixel in pixel row G3 as well as in pixel column S1 is sub-pixel X3 (not denoted in FIG. 1-5), the sub-pixel in pixel row G4 as well as in pixel column S1 is sub-pixel X4 (not denoted in FIG. 1-5), and the sub-pixel in pixel row G5 as well as in pixel column S1 is sub-pixel X5 (not denoted in FIG. 1-5). Referring to FIG. 1-5, in the display time of frame F1, polarity of the pixel voltage signal of sub-pixel X1 is “+”, polarity of the pixel voltage signal of sub-pixel X2 is “−”, polarity of the pixel voltage signal of sub-pixel X3 is “−”, polarity of the pixel voltage signal of sub-pixel X4 is “+”, and polarity of the pixel voltage signal of sub-pixel X5 is “+”. Owing to the fact that sub-pixel X1 is a sub-pixel in pixel row G1, and when sub-pixel X1 is charged, the voltage signal on the data line is set in advance, sub-pixel X1 can be charged completely without the need of changing the voltage signal on the data line. Therefore, luminance of sub-pixel X1 is 1. Owing to the fact that polarity of the pixel voltage signal of sub-pixel X1 is “+” and polarity of the pixel voltage signal of sub-pixel X2 is “−”, after charging of sub-pixel X1 is finished, the voltage signal on the data line needs to be changed (e.g., from +5 to −5). In this case, the voltage signal on the data line needs to undergo a falling edge and then sub-pixel X2 is charged. Because a certain time is consumed in the course of changing the voltage signal on the data line, the time taken for charging of sub-pixel X2 actually becomes shorter, and sub-pixel X2 is charged insufficiently. So, luminance of sub-pixel X2 is 0. Because both polarity of the pixel voltage signal of sub-pixel X2 and polarity of the pixel voltage signal of sub-pixel X3 are “−”, after charging of sub-pixel X2 is finished, the voltage signal on the data line can be used to charge sub-pixel X3 without the need of being changed. Hence, sub-pixel X3 can be charged completely, and luminance of sub-pixel X3 is 1 accordingly. Likewise, in the display time of frame F1, luminance of sub-pixel X4 is 0, and luminance of sub-pixel X5 is 1. As a result, in the display time of frame F1, luminance of five R sub-pixels in pixel column S1 is “10101” in sequence from pixel row G1 to pixel row G5. Also, in the display time of frame F2, luminance of five R sub-pixels in pixel column S1 is “10101” in sequence from pixel row G1 to pixel row G5; in the display time of frame F3, luminance of five R sub-pixels in pixel column S1 is “10101” in sequence from pixel row G1 to pixel row G5; and in the display time of frame F4, luminance of five R sub-pixels in pixel column S1 is “10101” in sequence from pixel row G1 to pixel row G5.

Please refer to FIG. 1-6, which is a schematic view showing luminance of sub-pixels in pixel column S1 as shown in FIG. 1-5 in the display time of four consecutive frames. Referring to FIG. 1-6, in the display time of different frames, luminance of sub-pixel X1 (not denoted in FIG. 1-6), luminance of sub-pixel X3 (not denoted in FIG. 1-6) and luminance of sub-pixel X5 (not denoted in FIG. 1-6) are always 1, and luminance of sub-pixel X2 (not denoted in FIG. 1-6) and luminance of sub-pixel X4 (not denoted in FIG. 1-6) are always 0. Therefore, with respect to the whole display panel, in the display time of each frame, luminance of each of pixel row G1 where sub-pixel X1 lies, pixel row G3 where sub-pixel X3 lies and pixel row G5 where sub-pixel X5 lies is 1, while luminance of each of pixel row G2 where sub-pixel X2 lies and pixel row G4 where sub-pixel X4 lies is 0. Thus, bright and dark stripes that are visible to human eyes appear on the display panel.

It is to be noted that, descriptions have been made above by taking the same gray-level to sub-pixels as an example, and in actual applications, at different gray-levels, as long as the above situation of flip-over for inverse polarities exists, bright and dark stripes that are visible to human eyes occurs. Details are omitted here.

Please refer to FIG. 2-1, which is a method flowchart showing a driving method of a display panel provided by an embodiment of the present disclosure. The driving method of the display panel is configured for driving a display panel to realize image display, and the display panel may be a liquid crystal display panel. Moreover, the display panel includes a plurality of sub-pixels arranged in the form of a matrix, which includes a plurality of pixel rows and a plurality of pixel columns, and a plurality of sub-pixels are included in each of the pixel rows and each of the pixel columns, respectively. Referring to FIG. 2-1, the driving method of the display panel includes the following operation:

Step 201, in a 2ⁿ-dot reverse mode, with the display duration of 2ⁿ⁺¹ frames as a scan cycle, a scan action is performed repetitively.

Please refer to FIG. 2-2, which is a flowchart showing a method of performing a scan action provided by the embodiment as shown in FIG. 2-1. Referring to FIG. 2-2, the method includes the following operations:

Sub-step 2011, in the display time of an (a)th frame, a pixel voltage signal is applied to each of sub-pixels of the display panel, so that every 2ⁿ⁺¹ consecutive pixel rows of the display panel form one pixel polarity repeat group and then a plurality of pixel polarity repeat groups are obtained. Polarities of pixel voltage signal of any two adjacent sub-pixels in same one pixel row in each of the pixel polarity repeat groups are in inverse, and for same one pixel column in each of the pixel polarity repeat groups, polarities of pixel voltage signal of sub-pixels in the (i)th pixel row and polarities of pixel voltage signal of sub-pixels in the (2ⁿ+i)th pixel row are in inverse. Here, a, n and i are all integers greater than or equal to 1, and a<2ⁿ⁺¹, i≤2ⁿ.

Sub-step 2012, in the display time of an (a+1)th frame, a pixel voltage signal is applied to each of sub-pixels of the display panel, so that the first 2ⁿ pixel rows of each of the pixel polarity repeat groups and the last 2ⁿ pixel rows of each of the pixel polarity repeat groups each meet a preset polarity condition, which is that, polarities of pixel voltage signal of sub-pixels of b pixel rows remain unchanged with respect to the polarities in the display time of the (a)th frame, and polarities of pixel voltage signal of sub-pixels of the rest pixel rows are changed with respect to the polarities in the display time of the (a)th frame, where the b pixel rows in the first 2ⁿ pixel rows are not adjacent to the b pixel rows in the last 2ⁿ pixel rows, b is an integer greater than or equal to 1, and b<2ⁿ, and moreover, in case that b is larger than 1, the b pixel rows are consecutive.

In summary, according to the driving method of the display panel provided by the embodiment of the present disclosure, within each scan cycle, in the course of driving liquid crystal molecules to flip over, the first 2ⁿ pixel rows of each of the pixel polarity repeat groups and the last 2ⁿ pixel rows of each of the pixel polarity repeat groups each meet a preset polarity condition. The preset polarity condition is that, polarities of pixel voltage signal of sub-pixels of b pixel rows remain unchanged, and polarities of pixel voltage signal of sub-pixels of the rest pixel rows are changed, wherein the b pixel rows in the first 2ⁿ pixel rows are not adjacent to the b pixel rows in the last 2ⁿ pixel rows, and b is an integer greater than or equal to 1. Owing to the fact that polarities of pixel voltage signal of sub-pixels of b pixel rows remain unchanged, and polarity of pixel voltage signal of sub-pixels of other pixel rows is changed, such a problem that the defect of bright and dark stripes which are visible to human eyes occurs to the display panel can be solved. Thus, an effect of alleviating occurrence of the defect of bright and dark stripes which are visible to human eyes to the display panel is achieved.

Here, the display time durations of all the 2ⁿ⁺¹ frames is equal. In the above sub-step 2011 and sub-step 2012, the pixel voltage signal, amplitude of which is equal to a preset amplitude, may be applied to each of sub-pixels of the display panel, and in the display time of different frames, amplitudes of the pixel voltage signals applied to each of sub-pixels of the display panel are equal. For example, in the display time of the (a)th frame and in the display time of the (a+1)th frame, the pixel voltage signal, the amplitude of which is equal to 5V, is applied to each of sub-pixels of the display panel. Each of sub-pixels of the display panel includes a thin film transistor (TFT), and the display panel further includes gate lines corresponding to the plurality of pixel rows on a one-to-one basis and data lines corresponding to the plurality of pixel columns on a one-to-one basis. Gate electrodes of TFTs of all the sub-pixels in one pixel row are all connected to same one gate line, and source electrodes of TFTs of all sub-pixels in one pixel column are all connected to same one data line. Turning-on and turning-off of the TFT of a sub-pixel can be controlled by a gate line, and when the TFT of the sub-pixel is turned on, the sub-pixel can be charged by the data line connected to the source electrode of the TFT, so as to apply a pixel voltage signal to the sub-pixel. Regarding the concrete process of applying the voltage signal, the related technology may be referred, and details are omitted here in the embodiments of the present disclosure.

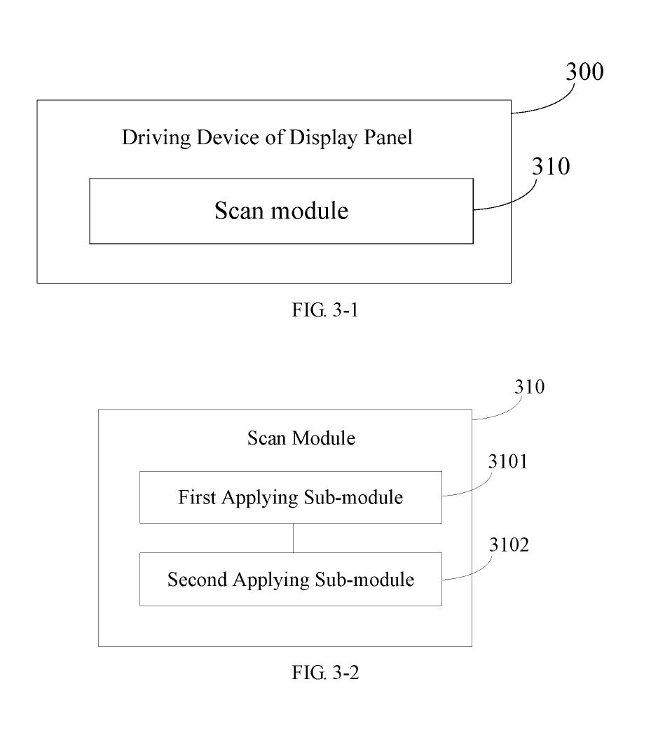

In embodiments of the present disclosure, n is an integer greater than or equal to 1, and description will be made in the embodiment of the present disclosure with reference to an example in which the 2ⁿ-dot reverse mode is two-dot reverse mode. In this case, 2ⁿ=2, and thus, n=1, and 2ⁿ⁺¹=4. Please refer to FIG. 2-3, which is a schematic view showing the polarity variance of the pixel voltage signals of each sub-pixel of a display panel in the display time of four consecutive frames provided by an embodiment of the present disclosure. Description will be made in the FIG. 2-3 with reference to an example in which the four consecutive frames include frame F1 to frame F4. The (a)th frame may be any of frame F1 to frame F4 other than frame F4, and the (a+1)th frame is the frame subsequent to the (a)th frame. Exemplarily, in case that the (a)th frame is frame F1, the (a+1)th frame is frame F2; in case that the (a)th frame is frame F2, the (a+1)th frame is frame F3; and in case that the (a)th frame is frame F3, the (a+1)th frame is frame F4. Description will be made for an embodiment of the present disclosure with reference to an example in which the (a)th frame is frame F1 and the (a+1)th frame is frame F2. Referring to FIG. 2-3, in the above sub-step 2011, in the display time of frame F1, a pixel voltage signal may be applied to each of sub-pixels of the display panel, so that polarities of pixel voltage signal of sub-pixels in pixel column S1 are “+−−++” in sequence from pixel row G1 to pixel row G5; polarities of pixel voltage signal of sub-pixels in pixel column S2 are “−++−−” in sequence from pixel row G1 to pixel row G5; polarities of pixel voltage signal of sub-pixels in pixel column S3 are “+−−++” in sequence from pixel row G1 to pixel row G5; polarities of pixel voltage signal of sub-pixels in pixel column S4 are “−++−−” in sequence from pixel row G1 to pixel row G5; polarities of pixel voltage signal of sub-pixels in pixel column S5 are “+−−++” in sequence from pixel row G1 to pixel row G5; and polarities of pixel voltage signal of sub-pixels in pixel column S6 are “−++−−” in sequence from pixel row G1 to pixel row G5. Referring to FIG. 2-3, every 4 (2ⁿ⁺¹=2¹⁺¹=4) consecutive pixel rows of the display panel form one pixel polarity repeat group and then a plurality of pixel polarity repeat groups are obtained. Polarities of pixel voltage signal of any two adjacent sub-pixels in same one pixel row in each of the pixel polarity repeat groups are in inverse, and for same one pixel column in each of the pixel polarity repeat groups, polarities of pixel voltage signal of sub-pixels in the (i)th pixel row and polarities of pixel voltage signal of sub-pixels in the (2+i)th (2ⁿ+i=2¹+i) pixel row are in inverse. Here, a, n and i are all integers greater than or equal to 1, and a<2ⁿ⁺¹, i≤2ⁿ. Exemplarily, as shown in FIG. 2-3, in the display time of frame F1, such four consecutive pixel rows as pixel rows G1 to G4 form one pixel polarity repeat group, and such four consecutive pixel rows as pixel row G5, pixel rows G6 to G8 (each of which is not shown in FIG. 2-3) form one pixel polarity repeat group; in a same way, a plurality of pixel polarity repeat groups can be obtained. In the pixel polarity repeat group formed by pixel rows G1 to G4, polarities of pixel voltage signal of any two adjacent sub-pixels in same one pixel row (e.g., pixel row G1) are in inverse. For the same pixel column in each of the pixel polarity repeat groups, polarities of pixel voltage signal of sub-pixels in the (i)th pixel row and polarities of pixel voltage signal of sub-pixels in the (2+i)th pixel row are in inverse. For example, when i=1, 2+i=3, and when i=2, 2+i=4. That is, in each of the pixel polarity repeat groups, for same one pixel column, polarity of pixel voltage signal of the sub-pixel in the first pixel row and polarity of pixel voltage signal of the sub-pixel in the third pixel row are in inverse, and polarity of pixel voltage signal of the sub-pixel in the second pixel row and polarity of pixel voltage signal of the sub-pixel in the fourth pixel row are in inverse.

In an embodiment, sub-step 2012 includes that, in the display time of the (a+1)th frame, a pixel voltage signal is applied to each of sub-pixels of the display panel, so that polarities of pixel voltage signal of sub-pixels in the (m×2ⁿ−(a−1))th pixel row in each of pixel polarity repeat groups maintain unchanged with respect to the polarities in the display time of the (a)th frame, and polarities of pixel voltage signal of sub-pixels in the rest pixel rows are changed with respect to the polarities in the display time of the (a)th frame, wherein m is an integer greater than or equal to 1.

With the (a+1)th frame being frame F2 as an example, referring to FIG. 2-3, in the above sub-step 2012, in the display time of frame F2, a pixel voltage signal may be applied to each of sub-pixels of the display panel, so that in sub-pixels of the display panel, polarities of pixel voltage signal of sub-pixels in pixel column S1 are “−−++−” in sequence from pixel row G1 to pixel row G5, polarities of pixel voltage signal of sub-pixels in pixel column S2 are “++−−+” in sequence from pixel row G1 to pixel row G5, polarities of pixel voltage signal of sub-pixels in pixel column S3 are “−−++−” in sequence from pixel row G1 to pixel row G5, polarities of pixel voltage signal of sub-pixels in pixel column S4 are “++−−+” in sequence from pixel row G1 to pixel row G5, polarities of pixel voltage signal of sub-pixels in pixel column S5 are “−−++−” in sequence from pixel row G1 to pixel row G5, and polarities of pixel voltage signal of sub-pixels in pixel column S6 are “++−−+” in sequence from pixel row G1 to pixel row G5. Referring to FIG. 2-3, in the plurality of pixel polarity repeat groups formed during the time when frame F1 is displayed, the first 2 (2ⁿ=2¹=2) pixel rows of each of the pixel polarity repeat groups and the last 2(2ⁿ=2¹=2) pixel rows of each of the pixel polarity repeat groups each meet a preset polarity condition, which is that, polarity of pixel voltage signal of sub-pixels of b pixel row(s) remains unchanged with respect to its polarity in the display time of the (a)th frame (frame F1), and polarities of pixel voltage signal of sub-pixels of the rest pixel rows are changed with respect to the polarity in the display time of the (a)th frame, wherein the b pixel row(s) in the first 2 pixel rows are not adjacent to the b pixel row(s) in the last 2 pixel rows, b is an integer greater than or equal to 1. In FIG. 2-3, b=1. Referring to FIG. 2-3, in the pixel polarity repeat group formed by pixel rows G1 to G4, polarities of pixel voltage signal of sub-pixels in pixel rows G2 and pixel rows G4 remain unchanged with respect to the polarity in the display time of frame F1, and polarities of pixel voltage signal of sub-pixels in pixel row G and pixel row G3 are changed with respect to the polarities in the display time of frame F1. Here, the pixel row in each of pixel polarity repeat groups, for which polarities of pixel voltage signals remain unchanged, can be obtained by calculating with formula (m×2ⁿ−(a−1)). In the display time of frame F2, a+1=2, a=1, m is an integer greater than or equal to 1, and therefore, when m=1, it can be obtained by calculating with the above formula that polarities of pixel voltage signal of sub-pixels in the (2m)th row remain unchanged with respect to the polarities in the display time of the (a)th frame. That is, in each of pixel polarity repeat groups, polarities of pixel voltage signal of sub-pixels in 2^{nd} row and 4^{th} row remain unchanged with respect to the polarities in the display time of the (a)th frame. For example, in the pixel polarity repeat group formed by pixel rows G1 to G4, it can be obtained by calculating with the formula that polarities of pixel voltage signal of sub-pixels in pixel row G2 and pixel row G4 remain unchanged with respect to the polarities in the display time of frame F1.

Please refer to FIG. 2-4, which is a schematic view showing variances in luminance and polarity of a pixel voltage signal for sub-pixels in pixel column S1 as shown in FIG. 2-3 in the display time of four consecutive frames. Provided that the sub-pixel in pixel row G1 as well as in pixel column S1 is sub-pixel X1 (not denoted in FIG. 2-4), the sub-pixel in pixel row G2 as well as in pixel column S1 is sub-pixel X2 (not denoted in FIG. 2-4), the sub-pixel in pixel row G3 as well as in pixel column S1 is sub-pixel X3 (not denoted in FIG. 2-4), the sub-pixel in pixel row G4 as well as in pixel column S1 is sub-pixel X4 (not denoted in FIG. 2-4), and the sub-pixel in pixel row G5 as well as in pixel column S1 is sub-pixel X5 (not denoted in FIG. 2-4). Referring to FIG. 2-4, in the display time of frame F1, polarity of the pixel voltage signal of sub-pixel X1 is “+”, polarity of the pixel voltage signal of sub-pixel X2 is “−”, polarity of the pixel voltage signal of sub-pixel X3 is “−”, polarity of the pixel voltage signal of sub-pixel X4 is “+”, and polarity of the pixel voltage signal of sub-pixel X5 is “+”. Owing to the fact that sub-pixel X1 is the sub-pixel in pixel row G1, and when sub-pixel X1 is charged, the voltage signal over the data line is set in advance, sub-pixel X1 can be charged completely without the need of changing the voltage signal over the data line. Therefore, luminance of sub-pixel X1 is 1. Owing to the fact that polarity of the pixel voltage signal of sub-pixel X1 is “+” and polarity of the pixel voltage signal of sub-pixel X2 is “−”, after charging of sub-pixel X1 is finished, the voltage signal over the data line needs to be changed (e.g., from +5 to −5). In this case, the voltage signal over the data line needs to undergo a falling edge and then it can charge sub-pixel X2. Because certain time is consumed in the course of changing the voltage signal over the data line, the time taken for charging of sub-pixel X2 actually becomes shorter, and sub-pixel X2 is charged insufficiently. Therefore, luminance of sub-pixel X2 is 0. Because polarity of the pixel voltage signal of each of sub-pixel X2 and sub-pixel X3 is “−”, after charging of sub-pixel X2 is finished, the voltage signal over the data line can be used to charge sub-pixel X3 without the need of being changed. Hence, sub-pixel X3 can be charged completely, and luminance of sub-pixel X3 is 1 accordingly. The rest sub-pixels can be charged in the same way. In the display time of frame F1, luminance of sub-pixel X4 is 0, and luminance of sub-pixel X5 is 1. As a result, in the display time of frame F1, luminance of the five R sub-pixels in pixel column S1 is “10101” in sequence from pixel row G1 to pixel row G5. In the display time of frame F2, polarity of the pixel voltage signal of sub-pixel X1 is “−”, polarity of the pixel voltage signal of sub-pixel X2 is “−”, polarity of the pixel voltage signal of sub-pixel X3 is “+”, polarity of the pixel voltage signal of sub-pixel X4 is “+”, and polarity of the pixel voltage signal of sub-pixel X5 is “−”. Owing to the fact that sub-pixel X1 is the sub-pixel in pixel row G1, and when sub-pixel X1 is charged, the voltage signal over the data line is set in advance, sub-pixel X1 can be charged completely without the need of changing the voltage signal over the data line. Therefore, luminance of sub-pixel X1 is 1. Owing to the fact that polarities of the pixel voltage signals of sub-pixel X1 and sub-pixel X2 are “−”, after charging of sub-pixel X1 is finished, the voltage signal over the data line can be used to charge sub-pixel X2 without the need of being changed. Hence, sub-pixel X2 can be charged completely, and luminance of sub-pixel X2 is 1. The rest sub-pixels can be charged in the same way. In the display time of frame F2, luminance of sub-pixel X3 is 0, luminance of sub-pixel X4 is 1, and luminance of sub-pixel X5 is 0. As a result, in the display time of frame F2, luminance of the five R sub-pixels in pixel column S1 is “11010” in sequence from pixel row G1 to pixel row G5. In accordance with the same principle, in the display time of frame F3, luminance of the five R sub-pixels in pixel column S1 is “10101” in sequence from pixel row G1 to pixel row G5; and in the display time of frame F4, luminance of five R sub-pixels in pixel column S1 is “11010” in sequence from pixel row G1 to pixel row G5.

Please refer to FIG. 2-5, which is a schematic view showing luminance of sub-pixels in pixel column S1 as shown in FIG. 2-4 in the display time of four consecutive frames. Referring to FIG. 2-5, in the display time of different frames in frame F1 to frame F4, luminance of sub-pixel X2 (not shown in FIG. 2-5), luminance of sub-pixel X3 (not shown in FIG. 2-5), luminance of sub-pixel X4 (not shown in FIG. 2-5) and luminance of sub-pixel X5 (not shown in FIG. 2-5) are not all 0 or not all 1. With respect to the whole display panel, luminance of the same sub-pixel in two adjacent frames is presented in such a way that brightness and darkness are neutralized. As such, luminance of each of sub-pixels can be guaranteed effectively, and then luminance of each row is guaranteed. Moreover, it is ensured that luminance of all other pixel rows than the first row is uniform. Because luminance of each of pixel rows is enhanced, even if the first row suffers from luminance variation, it will not be perceived in a user's vision. In this way, occurrence of bright and dark stripes on the display panel can be solved effectively. Therefore, in an embodiment of the present disclosure, when n=1, the driving method of a display panel may be performed by taking the display time of 2ⁿ⁺¹=4 frames as one scan cycle, in other words, the driving method of the display panel may be performed by taking every 2ⁿ⁺¹−4 frames as one frame unit. Exemplarily, as shown in FIG. 2-6, the driving method of a display panel may be performed by taking frame F1 to frame F4 as one frame unit.

It is to be noted that, descriptions have been made above with reference to an example in which the (a)th frame is frame F1 and the (a+1)th frame is frame F2. In actual operations, the (a)th frame may also be frame F2 or frame F3, and the (a+1)th frame may also be frame F3 or frame F4. Regarding the implementing process, the foregoing may be referred to, and the embodiments of the present disclosure are not described here for the purpose of simplicity.

It is also to be noted that, descriptions have been made above with 2ⁿ⁺¹=4 as an example, and in an actual application, n may take any integer value that is larger than or equal to 1. Hence, for different values of n, 2^{n 1} may also take other value. For example, when n=2, 2ⁿ⁺¹=8; when n=3, 2ⁿ⁺¹=16, and when n=4, 2⁺¹=32. Further description will be given below to the driving method of a display panel provided by an embodiment of the present disclosure with reference to an example in which n=2, 2ⁿ⁻¹=8.

Please refer to FIG. 2-7, which is a schematic view showing the polarity variance of the pixel voltage signal of each sub-pixel of a display panel in the display time of eight consecutive frames provided by an embodiment of the present disclosure. Description is made in FIG. 2-7 with reference to an example in which the eight consecutive frames are frame F1 to frame F8, wherein the (a)th frame may be any frame in frame F1 to frame F8 other than frame F8, and the (a+1)th frame is the frame subsequent to the (a)th frame. In an embodiment of the present disclosure, description is made with reference to an example in which the (a)th frame is frame F1 and the (a+1)th frame is frame F2. Referring to FIG. 2-7, in the above sub-step 2011, in the display time of frame F1, a pixel voltage signal may be applied to each of sub-pixels of the display panel, so that in sub-pixels of the display panel, polarities of pixel voltage signal of sub-pixels in pixel column S1 are “++++−−++++−−−” in sequence from pixel row G1 to pixel row G16; polarities of pixel voltage signal of sub-pixels in pixel column S2 are “−−−−++++−−−−++++” in sequence from pixel row G1 to pixel row G16; polarities of pixel voltage signal of sub-pixels in pixel column S3 are “++++−−−−++++−−−−” in sequence from pixel row G1 to pixel row G16; polarities of pixel voltage signal of sub-pixels in pixel column S4 are “−−−−++++−−−−++++” in sequence from pixel row G1 to pixel row G16; polarities of pixel voltage signal of sub-pixels in pixel column S5 are “++++−−−−++++−−−−” in sequence from pixel row G1 to pixel row G16; and polarities of pixel voltage signal of sub-pixels in pixel column S6 are “−−−−++++−−−−++++” in sequence from pixel row G1 to pixel row G16. Referring to FIG. 2-7, every 8 (2ⁿ⁺¹=2²⁺¹=8) consecutive pixel rows of the display panel form one pixel polarity repeat group and then a plurality of pixel polarity repeat groups are obtained. Polarities of pixel voltage signal of any two adjacent sub-pixels in the same pixel row in each of the pixel polarity repeat groups are in inverse, and for the same pixel column in each of the pixel polarity repeat groups, polarities of pixel voltage signal of sub-pixels in the (i)th pixel row and polarities of pixel voltage signal of sub-pixels in the (4+i)th (2ⁿ+i =2²+i) pixel row are in inverse. Here, a, n and i are all integers greater than or equal to 1, and a<2ⁿ⁻¹, i≤2ⁿ. Exemplarily, as shown in FIG. 2-7, in the display time of frame F1, such eight consecutive pixel rows as pixel rows G1 to G8 form one pixel polarity repeat group, and such eight consecutive pixel rows as pixel row G9 to G16 form one pixel polarity repeat group. In the same way, a plurality of pixel polarity repeat groups can be obtained. In a pixel polarity repeat group formed by pixel rows G1 to G8, polarities of pixel voltage signal of any two adjacent sub-pixels in the same pixel row (e.g., pixel row G1) are in inverse. For the same pixel column in each of the pixel polarity repeat groups, polarity of pixel voltage signal of sub-pixels in the (i)th pixel row and polarity of pixel voltage signal of sub-pixels in the (4+i)th pixel row are in inverse. For example, when i=1, 4+i=5; when i=2, 4+i=6; when i=3, 4+i=7; and when i=4, 4+i=8. That is, in each of the pixel polarity repeat groups, for the same pixel column, polarity of pixel voltage signal of the sub-pixel in the first pixel row and polarity of pixel voltage signal of the sub-pixel in the fifth pixel row are in inverse, polarity of pixel voltage signal of the sub-pixel in the second pixel row and polarity of pixel voltage signal of the sub-pixel in the sixth pixel row are in inverse, polarity of pixel voltage signal of the sub-pixel in the third pixel row and polarity of pixel voltage signal of the sub-pixel in the seventh pixel row are in inverse, polarity of pixel voltage signal of the sub-pixel in the fourth pixel row and polarity of pixel voltage signal of the sub-pixel in the eighth pixel row are in inverse.

In an embodiment, sub-step 2012 includes that, in the display time of the (a+1)th frame, a pixel voltage signal is applied to each of sub-pixels of the display panel, so that polarities of pixel voltage signal of sub-pixels in the (m×2ⁿ−(a−1))th pixel row in each of pixel polarity repeat groups maintain unchanged with respect to the polarities in the display time of the (a)th frame, and polarities of pixel voltage signal of sub-pixels in the rest pixel rows are changed with respect to the polarities in the display time of the (a)th frame, where m is an integer greater than or equal to 1.

With the (a+1)th frame being frame F2 as an example, referring to FIG. 2-7, in the above sub-step 2012, in the display time of frame F2, a pixel voltage signal may be applied to each of sub-pixels of the display panel, so that in sub-pixels of the display panel, polarities of pixel voltage signal of sub-pixels in pixel column S1 are “−−−++++−−−−++++−” in sequence from pixel row G1 to pixel row G16, polarities of pixel voltage signal of sub-pixels in pixel column S2 are “+++−−−−++++−−−−+” in sequence from pixel row G1 to pixel row G16, polarities of pixel voltage signal of sub-pixels in pixel column S3 are “−−−++++−−−−++++−” in sequence from pixel row G1 to pixel row G16, polarities of pixel voltage signal of sub-pixels in pixel column S4 are “+++−−−−++++−−−−+” in sequence from pixel row G1 to pixel row G16, polarities of pixel voltage signal of sub-pixels in pixel column S5 are “−−−++++−−−++++−” in sequence from pixel row G1 to pixel row G16, and polarities of pixel voltage signal of sub-pixels in pixel column S6 are “+++−−−−++++−−−−+” in sequence from pixel row G1 to pixel row G16. Referring to FIG. 2-7, in the plurality of pixel polarity repeat groups formed during the time when frame F1 is displayed, the former 4(2ⁿ=2²=4) pixel rows of each of the pixel polarity repeat groups and the latter 4(2ⁿ=2²=4) pixel rows of each of the pixel polarity repeat groups each meet a preset polarity condition, which is that, polarity of pixel voltage signal of sub-pixels of b pixel row(s) remains unchanged with respect to the polarity in the display time of the (a)th frame (frame F1), and polarities of pixel voltage signal of sub-pixels of in the rest pixel rows are changed with respect to the polarities in the display time of the (a)th frame, where the b pixel row(s) in the former 4 pixel rows are not adjacent to the b pixel row(s) in the latter 4 pixel rows, b is an integer greater than or equal to 1, and in case that b is greater than 1, the b pixel rows are consecutive. In FIG. 2-7, b=1. Referring to FIG. 2-7, in the pixel polarity repeat group formed by pixel rows G1 to G8, polarities of pixel voltage signal of sub-pixels in pixel rows G4 and pixel rows G8 remain unchanged with respect to the polarities in the display time of frame F1, and polarities of pixel voltage signal of sub-pixels in pixel row G1 to pixel row G3 and pixel row G5 to pixel row G7 are changed with respect to the polarities in the display time of frame F1. The pixel row in each of pixel polarity repeat groups, for which polarity of pixel voltage signal remains unchanged, can be obtained by calculating with formula (m×2ⁿ−(a−1)). In the display time of frame F2, a+1=2, a=1, m is an integer greater than or equal to 1, and therefore, when m=1, it can be obtained by calculating with the above formula that polarities of pixel voltage signal of sub-pixels in the (4m)th row remain unchanged with respect to the polarities in the display time of the (a)th frame. That is, in each of pixel polarity repeat groups, polarities of pixel voltage signal of sub-pixels in the 4th row and the 8th row remain unchanged with respect to the polarities in the display time of the (a)th frame. For example, in the pixel polarity repeat group formed by pixel rows G1 to G8, it can be obtained by calculating with the above formula that polarities of pixel voltage signal of sub-pixels in pixel row G4 and pixel row G8 remain unchanged with respect to polarities in the display time of frame F1.

Please refer to FIG. 2-8, which is a schematic view showing variances in luminance and polarity of a pixel voltage signal for sub-pixels in pixel column S1 as shown in FIG. 2-7 in the display time of eight consecutive frames. Provided that the sub-pixel in pixel row G1 as well as in pixel column S1 is sub-pixel X1 (not denoted in FIG. 2-8), the sub-pixel in pixel row G2 as well as in pixel column S1 is sub-pixel X2 (not denoted in FIG. 2-8), the sub-pixel in pixel row G3 as well as in pixel column S1 is sub-pixel X3 (not denoted in FIG. 2-8), the sub-pixel in pixel row G4 as well as in pixel column S1 is sub-pixel X4 (not denoted in FIG. 2-8), the sub-pixel in pixel row G5 as well as in pixel column S1 is sub-pixel X5 (not denoted in FIG. 2-8), the sub-pixel in pixel row G6 as well as in pixel column S1 is sub-pixel X6 (not denoted in FIG. 2-8), the sub-pixel in pixel row G7 as well as in pixel column S1 is sub-pixel X7 (not denoted in FIG. 2-8), the sub-pixel in pixel row G8 as well as in pixel column S1 is sub-pixel X8 (not denoted in FIG. 2-8), the sub-pixel in pixel row G9 as well as in pixel column S1 is sub-pixel X9 (not denoted in FIG. 2-8), the sub-pixel in pixel row G10 as well as in pixel column S1 is sub-pixel X10 (not denoted in FIG. 2-8), the sub-pixel in pixel row G11 as well as in pixel column S1 is sub-pixel X11 (not denoted in FIG. 2-8), the sub-pixel in pixel row G12 as well as in pixel column S1 is sub-pixel X12 (not denoted in FIG. 2-8), the sub-pixel in pixel row G13 as well as in pixel column S1 is sub-pixel X13 (not denoted in FIG. 2-8), the sub-pixel in pixel row G14 as well as in pixel column S1 is sub-pixel X14 (not denoted in FIG. 2-8), the sub-pixel in pixel row G15 as well as in pixel column S1 is sub-pixel X15 (not denoted in FIG. 2-8), and the sub-pixel in pixel row G16 as well as in pixel column S1 is sub-pixel X16 (not denoted in FIG. 2-8).

Referring to FIG. 2-8, in the display time of frame F1, polarity of the pixel voltage signal of each of sub-pixel X1 to sub-pixel X4 is “+”, polarity of the pixel voltage signal of each of sub-pixel X5 to sub-pixel X8 is “−”, polarity of the pixel voltage signal of each of sub-pixel X9 to sub-pixel X12 is “+”, and polarity of the pixel voltage signal of each of sub-pixel X13 to sub-pixel X16 is “−”. Owing to the fact that sub-pixel X1 is the sub-pixel in pixel row G1, and when sub-pixel X1 is charged, the voltage signal over the data line is set in advance, sub-pixel X1 can be charged completely without the need of changing the voltage signal on the data line. Therefore, luminance of sub-pixel X1 is 1. Because polarities of pixel voltage signal of sub-pixel X1 and sub-pixel X2 are “+”, after charging of sub-pixel X1 is finished, the voltage signal over the data line can be used to charge sub-pixel X2 without the need of being changed, and sub-pixel X2 can be charged completely. Accordingly, luminance of sub-pixel X2 is 1. Likewise, in the display time of frame F1, luminance of sub-pixel X3 is 1, and luminance of sub-pixel X4 is 1. Owing to the fact that polarity of the pixel voltage signal of sub-pixel X4 is “+” and polarity of the pixel voltage signal of sub-pixel X5 is “−”, after charging of sub-pixel X4 is finished, the voltage signal over the data line needs to be changed (e.g., from +5 to −5). In this case, the voltage signal over the data line needs to undergo a falling edge and then it can charge sub-pixel X5. Because certain time is consumed in the course of changing the voltage signal over the data line, the time taken for charging of sub-pixel X5 actually becomes shorter, and sub-pixel X5 is charged insufficiently. So, luminance of sub-pixel X5 is 0. The rest sub-pixels are charged in the same way, and in the display time of frame F1, luminance of sub-pixel X6 is 1, luminance of sub-pixel X7 is 1, luminance of sub-pixel X8 is 1, luminance of sub-pixel X9 is 0, luminance of sub-pixel X10 is 1, luminance of sub-pixel X11 is 1, luminance of sub-pixel X12 is 1, luminance of sub-pixel X13 is 0, luminance of sub-pixel X14 is 1, luminance of sub-pixel X15 is 1, and luminance of sub-pixel X16 is 1. As a result, in the display time of frame F1, luminance of the sixteen R sub-pixels in pixel column S1 is “1111011101110111” in sequence from pixel row G1 to pixel row G16. Likewise, in the display time of frame F2, luminance of the sixteen R sub-pixels in pixel column S1 is “1110111011101110” in sequence from pixel row G1 to pixel row G16; in the display time of frame F3, luminance of the sixteen R sub-pixels in pixel column S1 is “1101110111011101” in sequence from pixel row G1 to pixel row G16; in the display time of frame F4, luminance of the sixteen R sub-pixels in pixel column S1 is “1011101110111011” in sequence from pixel row G1 to pixel row G16; in the display time of frame F5, luminance of the sixteen R sub-pixels in pixel column S1 is “1111011101110111” in sequence from pixel row G1 to pixel row G16; in the display time of frame F6, luminance of the sixteen R sub-pixels in pixel column S1 is “1110111011101110” in sequence from pixel row G1 to pixel row G16; .in the display time of frame F7, luminance of the sixteen R sub-pixels in pixel column S1 is “1101110111011101” in sequence from pixel row G1 to pixel row G16; and in the display time of frame F8, luminance of the sixteen R sub-pixels in pixel column S1 is “1011101110111011” in sequence from pixel row G1 to pixel row G16.

Please refer to FIG. 2-9, which is a schematic view showing luminance of sub-pixels in pixel column S1 as shown in FIG. 2-8 in the display time of eight consecutive frames. Referring to FIG. 2-9, in the display time of distinct frames in frame F1 to frame F16, luminance of every sub-pixel of sub-pixel X2 (not shown in FIG. 2-9) to sub-pixel X16 (not shown in FIG. 2-9) is not all 0 or not all 1, and in this way, the defect of bright and dark stripes on the display panel ca be relieved. Therefore, in an embodiment of the present disclosure, when n=2, the driving method of a display panel may be performed by taking the display time of 2ⁿ⁺¹=8 frames as one scan cycle, in other words, the driving method of the display panel may be performed by taking every 2ⁿ⁺¹=8 frames as one frame unit. The embodiment of the present disclosure is not described in detail for simplicity.

It is to be noted that, description has been made in an embodiment of the present disclosure with b=1 as an example, and in actual applications, b may take any positive integer value that is smaller than 2ⁿ (e.g., 2, 4 or the like). Embodiments of the present disclosure are not limited thereto.

It is also to be noted that, the driving method of a display panel has been exemplarily described in two cases where n=1 and n=2 according to embodiments of the present disclosure, and the case where n=3 or other value is similar to the foregoing embodiments. Regarding the implementing process, the above description can be referred to, and the embodiments of the present disclosure are not described in detail for simplicity.

It is to be explained for the supplementary purpose that, the driving method of the display panel provided by an embodiment of the present disclosure is mainly applied to the field of liquid crystal display panel, and it provides a new liquid crystal flip-over manner of a liquid crystal display panel, which especially relates to periodical alternation of polarities of pixel voltage signal of sub-pixels in a display picture at the same gray-level, so that superposition in time is obtained to compromise the luminance nonuniformity problem resulted from the charging time difference during reversal of polarity as for polarity of pixel voltage signals of sub-pixels in two adjacent pixel rows.

It is to be explained for the supplementary purpose that, with the rapid development of liquid crystal display technology, consumer's demands on performance and quality of a displayed picture (e.g., low power consumption, fine degree of the picture, and so on) are becoming higher and higher, and consideration of both a high degree of fineness and a low degree of power consumption cannot be achieved by current technologies at the same time. According to an embodiment of the present disclosure, with the use of four conventional picture reversal modes with low power consumption, by means of periodic superposition in time domain, low power consumption and display of high quality are achieved, and constraint to process conditions of panel is alleviated so as to achieve the goal of saving cost.

It is to be explained for the supplementary purpose that, according to the driving method of the display panel provided by an embodiment of the present disclosure, such a sub-pixel, polarity of the pixel voltage signal of which remains unchanged with respect to the previous frame, exists in each of frames, and in this way, it is possible that polarity variation of pixel voltage signals of sub-pixels in a time unit is reduced, and power consumption of the display panel is decreased. For example, with the refresh frequency of 60 Hz (hertz) as an example, in a two-dot reverse mode, the polarity of the pixel voltage signal of one sub-pixel needs to change 60 times within one second, while in case that the driving method of a display panel provided by an embodiment of the present disclosure is adopted, the polarity of the pixel voltage signal of one sub-pixel only needs to change 30 times within one second. Therefore, not only flip-over of liquid crystal is realized, but also power consumption can be decreased by half. When the refresh frequency is 60 HZ, the polarity of the pixel voltage signal of each of sub-pixels changes once at an interval of 16.6 ms (millisecond), namely, liquid crystal molecules flip over once at an interval of 16.6 ms. If liquid crystal molecules flip over once every 2 frames, then it is equivalent to the case that liquid crystal molecules flip over once every 16.6×2 ms. In this case, it is equivalent to the case that the refresh frequency is 30 HZ, which is exactly a critical point that can be perceived by human eyes. Therefore, normal display of the display panel can be guaranteed.

To sum up, according to the driving method of the display panel provided by an embodiment of the present disclosure, within each scan cycle, in the course of driving liquid crystal molecules to flip over, the first 2ⁿ pixel rows of each of the pixel polarity repeat groups and the last 2ⁿ pixel rows of each of the pixel polarity repeat groups each meet a preset polarity condition. The preset polarity condition is that, polarities of pixel voltage signal of sub-pixels of b pixel rows remain unchanged, and polarities of pixel voltage signal of sub-pixels of the rest pixel rows are changed, wherein the b pixel rows in the first 2ⁿ pixel rows are not adjacent to the b pixel rows in the last 2ⁿ pixel rows, and b is an integer greater than or equal to 1. Owing to the fact that polarities of pixel voltage signal of sub-pixels of b pixel rows remain unchanged, and polarities of pixel voltage signal of sub-pixels of the rest pixel rows are changed, such a problem that the defect of bright and dark stripes which are visible to human eyes occurs to the display panel can be solved. Thus, the effect of alleviating occurrence of the defect of bright and dark stripes which are visible to human eyes to the display panel is achieved.

According to the driving method of the display panel provided by an embodiment of the present disclosure, such a problem that the defect of bright and dark stripes which are visible to human eyes occurs to the display panel can be solved favorably, and moreover, liquid crystal molecules can also be flipped over periodically, so as to avoid liquid crystal molecules from being polarized and losing activity. Consequently, activity of liquid crystal molecules is guaranteed, and service life of a display panel is increased.

The following involves the device embodiments of the present disclosure, which can be used for implementing the method embodiments of the present disclosure. As for the details not disclosed in the device embodiments of the present disclosure, please refer to method embodiments of the present disclosure.

Please refer to FIG. 3-1, which is a block diagram showing a driving device 300 of a display panel provided by an embodiment of the present disclosure. The driving device 300 of the display panel can be used for implementing the driving method of the display panel provided by an embodiment shown in FIG. 2-1. The display panel includes a plurality of sub-pixels arranged in the form of a matrix, which includes a plurality of pixel rows and a plurality of pixel columns, and a plurality of sub-pixels are included in each of the pixel rows and each of the pixel columns. Referring to FIG. 3-1, the driving device 300 of the display panel includes:

a scan module 310, configured for in a 2ⁿ-dot reverse mode, with display direction of 2ⁿ⁺¹ frames as a scan cycle, performing a scan action repetitively. The scan module 310 may be, for example, embodied by an area scanner, a camera or a sensor.

Please refer to FIG. 3-2, which is a block diagram showing a scan module 310 provided by the embodiment as shown in FIG. 3-1. Referring to FIG. 3-2, the scan module 310 includes:

a first applying sub-module 3101, configured for in the display time of an (a)th frame, applying a pixel voltage signal to each of sub-pixels of the display panel, so that every 2ⁿ⁺¹ consecutive pixel rows of the display panel form one pixel polarity repeat group and a plurality of pixel polarity repeat groups are obtained. Polarities of pixel voltage signal of any two adjacent sub-pixels in the same pixel row in each of the pixel polarity repeat groups are in inverse, and for the same pixel column in each of the pixel polarity repeat groups, polarities of pixel voltage signal of sub-pixels in the (i)th pixel row and polarities of pixel voltage signal of sub-pixels in the (2+i)th pixel row are in inverse. Here, a, n and i are all integers greater than or equal to 1, and a<2ⁿ⁺¹, and i≤2ⁿ; and

a second applying sub-module 3102, configured for in the display time of an (a+1)th frame, applying a pixel voltage signal to each of sub-pixels of the display panel, so that the first 2ⁿ pixel rows of each of the pixel polarity repeat groups and the last 2ⁿ pixel rows of each of the pixel polarity repeat groups each meet a preset polarity condition, which is that, polarities of pixel voltage signal of sub-pixels of b pixel rows remain unchanged with respect to the polarities in the display time of the (a)th frame, and polarities of pixel voltage signal of sub-pixels of the rest pixel rows are changed with respect to the polarities in the display time of the (a)th frame, wherein the b pixel rows in the first 2ⁿ pixel rows are not adjacent to the b pixel rows in the last 2ⁿ pixel rows, b is an integer greater than or equal to 1, and b<2ⁿ, and moreover, in case that b is larger than 1, the b pixel rows are consecutive. The above first applying sub-module 3101 and the second applying sub-module 3102 may be, for example, embodied by a voltage controller, a processor chip or the like.

To sum up, according to driving device of the display panel provided by embodiments of the present disclosure, within each scan cycle, in the course of driving liquid crystal molecules to flip over, the first 2ⁿ pixel rows of each of the pixel polarity repeat groups and the last 2ⁿ pixel rows of each of the pixel polarity repeat groups each meet a preset polarity condition. The preset polarity condition is that, polarity of pixel voltage signal of sub-pixels of b pixel rows remains unchanged, and polarity of pixel voltage signal of sub-pixels of other pixel rows is changed, wherein the b pixel rows in the first 2ⁿ pixel rows are not adjacent to the b pixel rows in the last 2ⁿ pixel rows, and b is an integer greater than or equal to 1. Owing to the fact that polarity of pixel voltage signal of sub-pixels of b pixel rows remains unchanged, and polarity of pixel voltage signal of sub-pixels of other pixel rows is changed, such a problem that a defect of bright and dark stripes which are visible to human eyes occurs to the display panel can be solved. Thus, an effect of alleviating occurrence of the defect of bright and dark stripes which are visible to human eyes to the display panel is achieved.

In one embodiment, the second applying sub-module 3102 is configured for in the display time of the (a+1)th frame, applying a pixel voltage signal to each of sub-pixels of the display panel, so that polarities of pixel voltage signal of sub-pixels in the (m×2ⁿ−(a−1))th pixel row in each of pixel polarity repeat groups maintain unchanged with respect to the polarities in the display time of the (a)th frame, and polarities of pixel voltage signal of sub-pixels in the rest pixel rows are changed with respect to the polarities in the display time of the (a)th frame, wherein m is an integer greater than or equal to 1.

In one embodiment, the display time of all of 2ⁿ⁺¹ frames is equal.

In one embodiment, the first applying sub-module 3101 and the second applying sub-module 3102 are each configured for applying a pixel voltage signal, the amplitude of which is equal to a preset amplitude, to each of sub-pixels of the display panel.

In one embodiment, in the display time of different frames, amplitudes of the pixel voltage signals applied to each of sub-pixels of the display panel are equal to each other.

In one embodiment, the display panel is a liquid crystal display panel.

In summary, according to the driving device of the display panel provided by an embodiment of the present disclosure, within each scan cycle, in the course of driving liquid crystal molecules to flip over, the first 2ⁿ pixel rows of each of the pixel polarity repeat groups and the last 2ⁿ pixel rows of each of the pixel polarity repeat groups each meet a preset polarity condition. The preset polarity condition is that, polarities of pixel voltage signal of sub-pixels of b pixel rows remain unchanged, and polarities of pixel voltage signal of sub-pixels of the rest pixel rows are changed, wherein the b pixel rows in the first 2ⁿ pixel rows are not adjacent to the b pixel rows in the last 2ⁿ pixel rows, and b is an integer greater than or equal to 1. Owing to the fact that polarities of pixel voltage signal of sub-pixels of b pixel rows remain unchanged, and polarities of pixel voltage signal of sub-pixels of the rest pixel rows are changed, such the problem that the defect of bright and dark stripes which are visible to human eyes occurs to the display panel can be solved. Thus, the effect of alleviating occurrence of the defect of bright and dark stripes which are visible to human eyes to the display panel is achieved.

According to an embodiment of the present disclosure, there is further provided a display device, which includes a display panel and a driving device 300 of the display panel as shown in FIG. 3-1. The display device may be an electronic paper, a cell phone, a tablet computer, a television, a display, a notebook computer, a digital photo frame, a navigator or any other product or component having a display function.

In conclusion, according to the display device provided by an embodiment of the present disclosure, within each scan cycle, in the course of driving liquid crystal molecules to flip over, the first 2ⁿ pixel rows of each of the pixel polarity repeat groups and the last 2ⁿ pixel rows of each of the pixel polarity repeat groups each meet a preset polarity condition. The preset polarity condition is that, polarities of pixel voltage signal of sub-pixels of b pixel rows remain unchanged, and polarities of pixel voltage signal of sub-pixels of the rest pixel rows is changed, wherein the b pixel rows in the first 2ⁿ pixel rows are not adjacent to the b pixel rows in the last 2ⁿ pixel rows, and b is an integer greater than or equal to 1. Owing to the fact that polarities of pixel voltage signal of sub-pixels of b pixel rows remain unchanged, and polarities of pixel voltage signal of sub-pixels of the rest pixel rows are changed, such the problem that the defect of bright and dark stripes which are visible to human eyes occurs to the display panel can be solved. Thus, the effect of alleviating occurrence of the defect of bright and dark stripes which are visible to human eyes to the display panel is achieved.

As can be understood by those ordinarily skilled in the art, implementation of all or part of steps of the above embodiments may be accomplished by hardware, and may also be accomplished by instructing a related hardware with program. The program may be stored in a computer readable storage medium, and the storage medium mentioned above may be a read-only memory, a magnetic disk, an optical disk or the like.

What are described above is related to the illustrative embodiments of the disclosure only and not limitative to the scope of the disclosure; any modification, equivalent substitution, improvement and the like that are within the spirit and principle of the present disclosure should be within the protection scope of the present disclosure.

The application claims priority to the Chinese patent application No. 201610965795.9, filed on Oct. 28, 2016, the entire disclosure of which is incorporated herein by reference as part of the present application.

1. A driving method of a display panel, the display panel comprising a plurality of sub-pixels arranged in a form of a matrix, which include a plurality of pixel rows and a plurality of pixel columns, and each of pixel rows and each of pixel columns comprising sub-pixels respectively, the method comprising:
in a 2ⁿ-dot reverse mode, with display duration of 2ⁿ⁺¹ frames as a scan cycle, performing a scan action repetitively, the scan action including:
in display time of an (a)th frame, applying a pixel voltage signal to each of the sub-pixels of the display panel, so that every 2ⁿ⁺¹ consecutive pixel rows of the display panel form one pixel polarity repeat group and a plurality of pixel polarity repeat groups are obtained, wherein polarities of pixel voltage signal of any two adjacent sub-pixels in same one pixel row in each of the pixel polarity repeat groups are in inverse, and for same one pixel column in each of the pixel polarity repeat groups, a polarity of pixel voltage signal of sub-pixel in an (i)th pixel row and a polarity of pixel voltage signal of sub-pixel in a (2+i)th pixel row are in inverse, and a, n and i are all integers greater than or equal to 1, and a<2ⁿ⁺¹, i≤2ⁿ;
in display time of an (a+1)th frame, applying a pixel voltage signal to each of the sub-pixels of the display panel, so that first 2ⁿ pixel rows of each of the pixel polarity repeat groups and last 2ⁿ pixel rows of each of the pixel polarity repeat groups each meet a preset polarity condition, wherein the preset polarity condition is that, polarities of pixel voltage signal of sub-pixels of b pixel rows remain unchanged, and polarities of pixel voltage signal of sub-pixels of rest pixel rows are changed, the b pixel rows in the first 2ⁿ pixel rows are not adjacent to the b pixel rows in the last 2ⁿ pixel rows, b is an integer greater than or equal to 1, and b<2ⁿ, and moreover, in case that b is larger than 1, the b pixel rows are consecutive.

2. The method claimed as claim 1, wherein
applying a pixel voltage signal to each of the sub-pixels of the display panel, so that the first 2ⁿ pixel rows of each of the pixel polarity repeat groups and the last 2ⁿ pixel rows of each of the pixel polarity repeat groups each meet the preset polarity condition in the display time of an (a+1)th frame includes:
in the display time of the (a+1)th frame, applying a pixel voltage signal to each of sub-pixels of the display panel, so that polarities of pixel voltage signal of sub-pixels in an (m×2ⁿ (a−1))th pixel row in each of pixel polarity repeat groups maintain unchanged with respect to the polarities in the display time of the (a)th frame, and polarities of pixel voltage signal of sub-pixels in the rest pixel rows are changed with respect to the polarities in the display time of the (a)th frame, wherein m is an integer greater than or equal to 1.

3. The method claimed as claim 1, wherein display time of all of the 2ⁿ⁺¹ frames is equal.

4. The method claimed as claim 1, wherein applying a pixel voltage signal to each of the sub-pixels of the display panel comprises:
applying a pixel voltage signal, an amplitude of which is equal to a preset amplitude, to each of the sub-pixels of the display panel.

5. The method claimed as claim 4, wherein in display time of different frames, amplitudes of pixel voltage signals applied to each of sub-pixels of the display panel are equal.

6. The method claimed as claim 1, wherein the display panel is a liquid crystal display panel.

7. A driving device of a display panel, the display panel comprising a plurality of sub-pixels arranged in a form of a matrix, which include a plurality of pixel rows and a plurality of pixel columns, and each of pixel rows and each of pixel columns comprising sub-pixels respectively, the driving device of the display panel comprising:
a scan module, configured for in a 2ⁿ-dot reverse mode, with display duration of 2ⁿ⁺¹ frames as a scan cycle, performing a scan action repetitively,
the scan module comprising:
a first applying sub-module, configured for applying a pixel voltage signal to each of the sub-pixels of the display panel, so that every 2ⁿ⁺¹ consecutive pixel rows of the display panel form one pixel polarity repeat group and a plurality of pixel polarity repeat groups are obtained, wherein polarities of pixel voltage signal of any two adjacent sub-pixels in same one pixel row in each of the pixel polarity repeat groups are in inverse, and for same one pixel column in each of the pixel polarity repeat groups, a polarity of pixel voltage signal of sub-pixel in an (i)th pixel row and a polarity of pixel voltage signal of sub-pixel in a (2+i)th pixel row are in inverse, and a, n and i are all integers greater than or equal to 1, and a<2ⁿ⁺¹, i≤2ⁿ;
a second applying sub-module, configured for in display time of an (a+1)th frame, applying a pixel voltage signal to each of the sub-pixels of the display panel, so that first 2ⁿ pixel rows of each of the pixel polarity repeat groups and last 2ⁿ pixel rows of each of the pixel polarity repeat groups each meet a preset polarity condition, wherein the preset polarity condition is that, polarities of pixel voltage signal of sub-pixels of b pixel rows remain unchanged, and polarities of pixel voltage signal of sub-pixels of rest pixel rows are changed, the b pixel rows in the first 2ⁿ pixel rows are not adjacent to the b pixel rows in the last 2ⁿ pixel rows, b is an integer greater than or equal to 1, and b<2ⁿ, and moreover, in case that b is larger than 1, the b pixel rows are consecutive.

8. The driving device of the display panel claimed as claim 7, wherein,
the second applying sub-module further is configured for in the display time of the (a+1)th frame, applying a pixel voltage signal to each of sub-pixels of the display panel, so that polarities of pixel voltage signal of sub-pixels in an (m×2ⁿ−(a−1))th pixel row in each of pixel polarity repeat groups maintain unchanged with respect to the polarities in the display time of the (a)th frame, and polarities of pixel voltage signal of sub-pixels in the rest pixel rows are changed with respect to the polarities in the display time of the (a)th frame, wherein m is an integer greater than or equal to 1.

9. The driving device of the display panel claimed as claim 7, wherein display time of all of the 2ⁿ⁺¹ frames is equal.

10. The driving device claimed as claim 7, wherein
each of the first applying sub-module and the second applying sub-module acts to apply a pixel voltage signal, an amplitude of which is equal to a preset amplitude, to each of the sub-pixels of the display panel.

11. The driving device of the display panel claimed as claim 10, wherein in display time of different frames, amplitudes of pixel voltage signals applied to each of sub-pixels of the display panel are equal.

12. The driving device claimed as claim 7, wherein the display panel is a liquid crystal display panel.

13. A display device, comprising a display panel and the driving device claimed as claim 7.

14. A driving device of a display panel, the display panel comprising a plurality of sub-pixels arranged in a form of a matrix, which include a plurality of pixel rows and a plurality of pixel columns, and each of pixel rows and each of pixel columns comprising sub-pixels respectively, the driving device of the display panel comprising:
a scan circuit, configured for in a 2ⁿ-dot reverse mode, with display duration of 2ⁿ⁺¹ frames as a scan cycle, performing a scan action repetitively,
the scan circuit comprising:
a first applying sub-circuit, configured for applying a pixel voltage signal to each of the sub-pixels of the display panel, so that every 2ⁿ⁺¹ consecutive pixel rows of the display panel form one pixel polarity repeat group and a plurality of pixel polarity repeat groups are obtained, wherein polarities of pixel voltage signal of any two adjacent sub-pixels in same one pixel row in each of the pixel polarity repeat groups are in inverse, and for same one pixel column in each of the pixel polarity repeat groups, a polarity of pixel voltage signal of sub-pixel in an (i)th pixel row and a polarity of pixel voltage signal of sub-pixel in a (2+i)th pixel row are in inverse, and a, n and i are all integers greater than or equal to 1, and a<2ⁿ⁺¹, i≤2ⁿ;
a second applying sub-circuit, configured for in display time of an (a+1)th frame, applying a pixel voltage signal to each of the sub-pixels of the display panel, so that first 2ⁿ pixel rows of each of the pixel polarity repeat groups and last 2ⁿ pixel rows of each of the pixel polarity repeat groups each meet a preset polarity condition, wherein the preset polarity condition is that, polarities of pixel voltage signal of sub-pixels of b pixel rows remain unchanged, and polarities of pixel voltage signal of sub-pixels of rest pixel rows are changed, the b pixel rows in the first 2ⁿ pixel rows are not adjacent to the b pixel rows in the last 2ⁿ pixel rows, b is an integer greater than or equal to 1, and b<2ⁿ, and moreover, in case that b is larger than 1, the b pixel rows are consecutive.

15. The driving device of the display panel claimed as claim 14, wherein,
the second applying sub-circuit further is configured for in the display time of the (a+1)th frame, applying a pixel voltage signal to each of sub-pixels of the display panel, so that polarities of pixel voltage signal of sub-pixels in an (m×2ⁿ−(a−1))th pixel row in each of pixel polarity repeat groups maintain unchanged with respect to the polarities in the display time of the (a)th frame, and polarities of pixel voltage signal of sub-pixels in the rest pixel rows are changed with respect to the polarities in the display time of the (a)th frame, wherein m is an integer greater than or equal to 1.

16. The driving device of the display panel claimed as claim 14, wherein display time of all of the 2ⁿ⁺¹ frames is equal.

17. The driving device claimed as claim 14, wherein
each of the first applying sub-module and the second applying sub-module acts to apply a pixel voltage signal, an amplitude of which is equal to a preset amplitude, to each of the sub-pixels of the display panel.

18. The driving device of the display panel claimed as claim 17, wherein in display time of different frames, amplitudes of pixel voltage signals applied to each of sub-pixels of the display panel are equal.

19. The driving device claimed as claim 14, wherein the display panel is a liquid crystal display panel.

20. A display device, comprising a display panel and the driving device claimed as claim 14.
